(19) United States
(12) Patent Application Publication
(10) Pub. No.: US 2009/0124251 A1
(43) Pub. Date: May 14, 2009

(54) Method of Assessing Compatibility Between Applications and Processor Devices

(75) Inventor: Marc Niccolini, Aix En Provence (FR)

Correspondence Address: BUCHANAN, INGERSOLL & ROONEY PC, POST OFFICE BOX 1404, ALEXANDRIA, VA, 22313-1404, US

(73) Assignee: Gemplus,, Gemenos (FR)

(21) Appl. No.: 11/667,857

(22) PCT Filed: Nov. 4, 2005
(86) PCT No.: PCT/EP05/55748

§ 371 Date: May 16, 2007

(30) Foreign Application Priority Data
Nov. 17, 2004 (FR) 0412193

(51) Int. Cl. H04W 24/00; G06F 11/00; H04M 1/00

(52) U.S. Cl. 455/425; 714/47; 455/558

(57) ABSTRACT

A method of assessing compatibility between at least one application and at least one processing device that host and/or executes and/or interacts with the application. A comparison is carried out between: (i) at least one profile from among the profiles associated with the devices, that respectively describe the functions supported by each device, and (ii) at least one profile from among the profiles associated with the applications that respectively describe the functions used by each application, in order to sutomatically establish an analysis of the functional compatibility between one or more applications and one or more devices.

The present invention relates to a method of automatically assessing compatibility between applications and processing devices that are susceptible of hosting and/or executing and/or interacting with such applications, such devices non-limitingly being constituted by equipment of the mobile telephone type, by Personal Digital Assistants (PDAs) or the like, by computers of the personal computer (PC) type, or indeed by servers of the applications server type, etc.

The invention is applicable more particularly, but not exclusively, to devices of the type that store applications on board smart cards, such as Universal Integrated Circuit Cards (UICCs), which cards are provided with information processing and storage means, and include, in particular Subscriber Identity Modules (SIMs). In the description below, the term “SIM card” should be interpreted non-restrictively as being a multi-applications card. A device of the above-mentioned type comprises a mobile terminal (an item of mobile equipment (ME)) that co-operates with such a SIM card.

As regards the on-board applications, they are constituted, in particular, by Java applications (“applets”) suitable for being downloaded, and then executed, either on the SIM card (they are then more specifically known as “cardlets”), or else on the terminal (they are then known more specifically as “midlets”).

In this context, various technologies currently exist for developing applications.

In particular, the “SIM Toolkit” (STK) application is executed in the SIM card.

In practical manner, a specific piece of software (cardlet) is implemented in the SIM card of the terminal for the purpose of executing a given function (sending short messages, generating a tone, setting up a call, accessing the Internet, effecting bank transactions, etc.).

The terminal has a set of instructions and procedures referred to as a “SIM Application Toolkit”, by means of which the applications created on the SIM can interact with the functions of the terminal. Operation is as follows: the SIM card then sends an instruction of the SIM Application Toolkit type to the terminal, which executes it if the corresponding function is accommodated by the terminal, and then reports to the SIM card as to whether or not the instruction has been executed properly. The instructions can be related to dialogues between SIM and screen, SIM and keypad, SIM and radio interface, etc.

The functions offered by that standard make it possible to develop a very large number of distinct applications on the smart card, with a view to providing to the users “added value” mobile telephone services. The reader might refer usefully to the GSM (Global System for Mobile Communications) 11.14 Standard and to the 3GPP (3^{rd} Generation Partnership Project) Standard for more information.

Currently, the commercial success of STK technology is limited by the fact that mobile operators deploy, as default configurations, STK applications that use only those functions which are sure to be accommodated fully by the terminals in question, so as to guarantee that the applications developed are compatible with most terminals. Because such compatibility problems might arise, operators are therefore reticent to deploy STK applications with advanced functionality features.

In addition, when a user changes mobile terminal, the mobile operator cannot check automatically whether the applications installed in the SIM remain compatible with the new terminal.

Similarly, when the user changes SIM card, the mobile operator cannot check automatically whether the applications installed on the new SIM card and the applications stored in the terminal remain compatible with the overall environment (card, mobile terminal, cardlets, midlets).

The applications can also be developed using Java 2 Micro Edition (J2ME) technology, in which the application (the term “midlet” is used with that technology) can be executed in a terminal that has a J2ME platform dedicated to development and execution of applications downloadable for such terminals.

For that purpose, the platform comprises three main modules: a virtual machine, an Application Programming Interface (API) adapted to the type of terminal in question and identifying the usable functions, i.e. the operations that can be executed by the terminal, which functions are implemented by an application, and a configuration module defining the resources of the terminal.

In the J2ME execution environment, when an application uses functions or programming interfaces that are not accommodated by the terminal, an error occurs and the application cannot be used.

In addition, no means are currently available to the mobile operator for automatically retrieving an incompatibility or error status.

The above-mentioned drawbacks are not limited to the execution environments mentioned, and are encountered in the same manner in other environments such as, for example, Windows Mobile or BREW (Binary Runtime Environment for Wireless).

It appears that no solution is provided in the state of the art for enabling mobile operators and service providers to know automatically whether applications will be completely compatible from a functional point of view with processing devices that are susceptible of hosting and/or executing such applications or merely of interacting with them.

An object of the present invention is thus to remedy the above-mentioned drawbacks.

Then invention thus provides a method of assessing compatibility between at least one application and at least one processing device that hosts and/or executes and/or interacts with at least said application, said method being characterized in that it comprises comparison between at least one profile from among profiles that are associated with the devices and that respectively describe functions accommodated by each device and at least one profile from among profiles that are associated with the applications and that respectively describe functions used by each application, so as to establish automatically a diagnostic of functional compatibility between one or more applications and one or more devices.

In an implementation, with an application being designed to interact while it is being executed with functions accommodated by a device of the mobile terminal type, establishing the diagnostic of functional compatibility consists in performing a comparison whereby the profile that is associated with said terminal and that describes the functions accommodated by said terminal is compared with the profile that is associated with said application.

In a variant, with the application being hosted in a device of the SIM card type with which the mobile terminal co-operates, establishing the diagnostic of functional compatibility further consists in performing a comparison whereby the profile that is associated with said application is compared with a profile that is associated with the SIM card and that describes the functions accommodated by said card.

In another variant, with the application being linked, for the purposes of being executed, to at least one other application, establishing the diagnostic of functional compatibility further consists in performing a comparison whereby the profile that is associated with said at least one other application is compared with the profile that is associated with said terminal.

In another variant, with said at least one other application being stored in a SIM card with which said terminal co-operates, establishing the diagnostic of compatibility further consists in performing a comparison whereby the profile that is associated with said at least one other application is compared with a profile that is associated with the SIM card and that describes the functions accommodated by said card.

Advantageously, establishing the diagnostic of functional compatibility further consists in determining a list of the functions that are used by the application and/or by said at least one application to which it is linked, and that are not accommodated by the terminal or by the card.

Advantageously, the profiles are stored and updated in a configuration table that stores the execution environment associated with each application and the links existing between each application for the purposes of executing them.

Preferably, the method further consists in triggering specific actions depending on the compatibility diagnostic that is established.

In an implementation, the triggering of specific actions consists in upgrading the device(s) or in deactivating those ones of the functions used by the application(s) which are not accommodated.

Advantageously, the method is implemented at the customer end, at the server end, or in a manner in which it is shared between the server end and the customer end.

The invention also provides a software module for assessing the compatibility between at least one application and at least one processing device hosting and/or executing and/or interacting with at least said application, said software module being characterized in that it comprises instructions for causing the method of the invention to be executed by a computer system.

The invention also provides a mobile terminal, characterized in that it incorporates a software module of the invention.

The invention finally provides a smart card, characterized in that it incorporates a software module of the invention.

Other characteristics and advantages of the present invention will appear more clearly on reading the following description given by way of non-limiting illustrative example and with reference to the accompanying figures, in which:

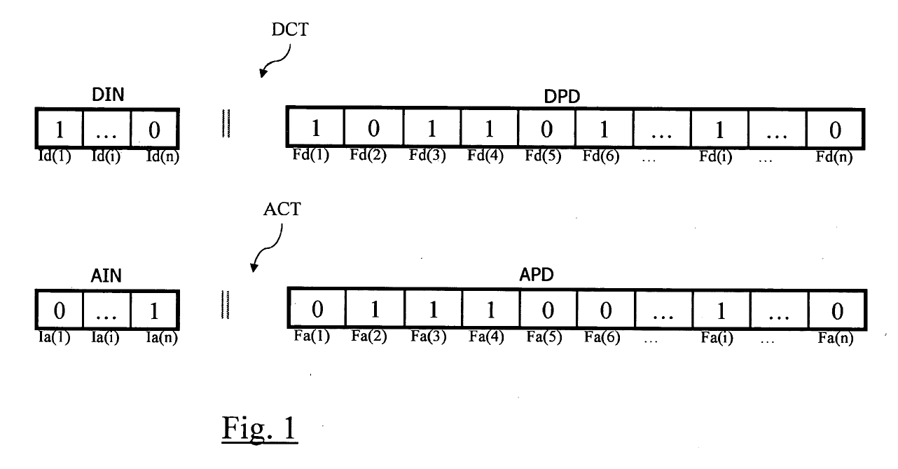

FIG. 1 shows a description example based on a string of bits that serve to identify a device or an application;

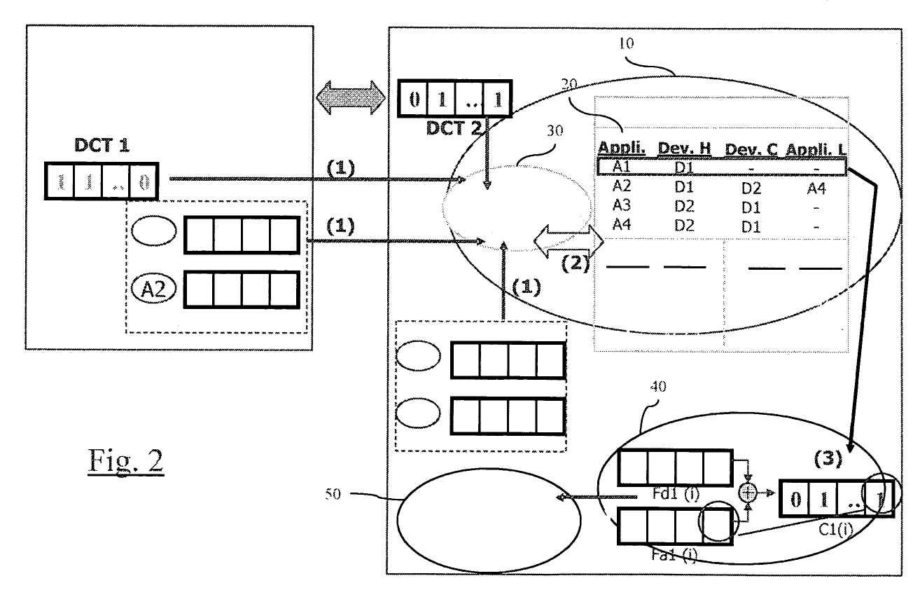

FIG. 2 shows an example of functional architecture for implementing a method of the invention, which architecture is based on a mobile terminal combined with a SIM card, hosting and executing a plurality of applications;

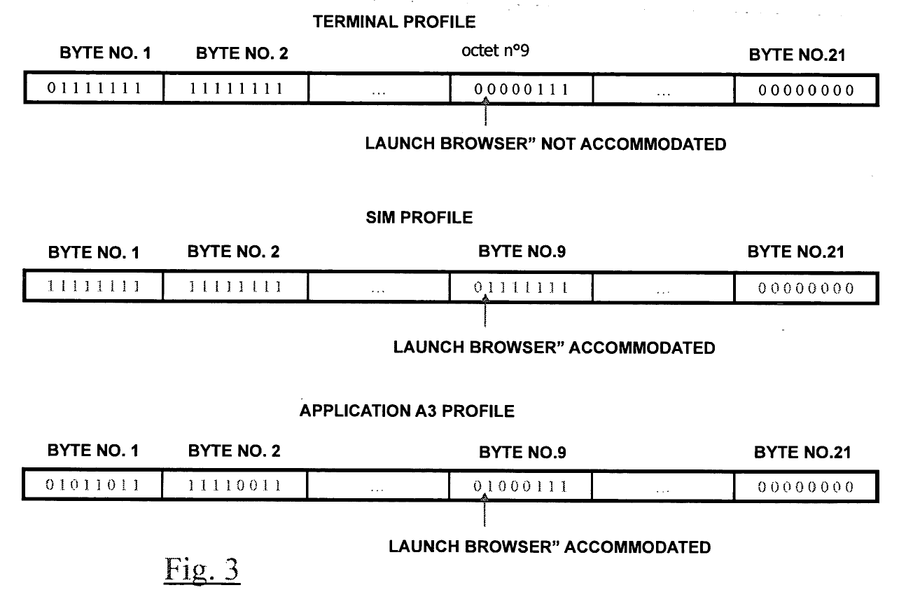

FIG. 3 shows an implementation in a SIM Toolkit environment; and

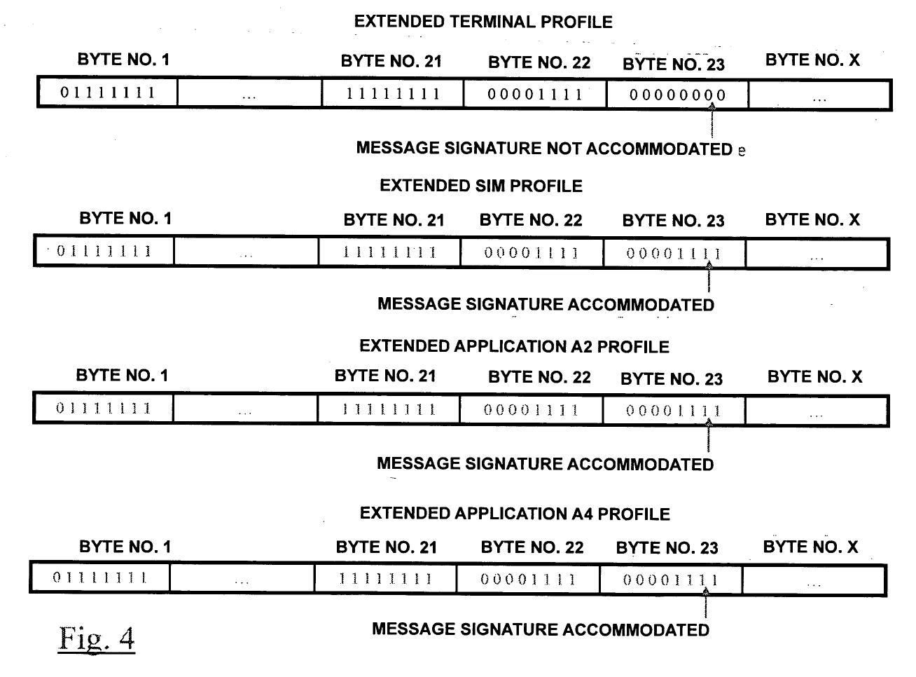

FIG. 4 shows an implementation in a J2ME environment.

The present invention is thus designed to make it possible automatically to assess the functional compatibility between a set of applications and a set of processing devices that host and/or execute and/or interact with the applications. In general, consideration is given to at least one host device which stores and executes the application and to at least one “connected” device which does not store the application but which is necessary for executing certain actions required for the application.

The application can also call and use another application to which it is linked for the purpose of being executed, it being possible for the other application to be stored in the same host device or in a connected different device.

For the purposes of the following description of an implementation of the invention, consideration is given more precisely to a set made up of a combination of a mobile terminal and of a SIM card with which the terminal co-operates. However, the invention is not limited to such a combination of devices.

The invention thus makes it possible automatically to establish a diagnostic of functional compatibility between applications and such a set onto which the applications can be downloaded, stored, and executed, either into the SIM card, or into the terminal. This diagnostic can be established before the application in question is downloaded, or indeed, in a variant, after the application has been downloaded.

For this purpose, use is made of the fact that the applications and each processing device are described respectively by a unique identifier and by a profile. FIG. 1 shows an example of a structure for describing the characteristics of a processing device DCT and for describing the characteristics of an application ACT, it being possible for a compatibility diagnostic of the invention to be based on this example of a structure.

Thus, the description of the characteristics of a customer device DCT, such as a mobile terminal, comprises a terminal identifier DIN, described by a string of bits Id(1), . . . , Id(n), typically the International Mobile Equipment Identity (IMEI), and a profile associated with the terminal DPD, describing in particular, in the form of a string of bits Fd(1), Fd(2) . . . , Fd(n), the list of the functions or group/class of functions accommodated by the terminal.

For example, in the 3GPP TS 51.014 v.4.3.0 Standard, the terminal profile contains the list of the functions of the SIM Application Toolkit type that are accommodated by the terminal. One bit is used for encoding each function of this type. A bit placed at “1” then indicates that the function in question encoded by said bit Fd(i) is accommodated by the terminal and a bit placed at “0” indicates that the function in question is not accommodated by the terminal.

It should be noted that if the customer device is constituted both by the mobile terminal and by a SIM card, then a description of the characteristics of the SIM card including, in the same way, an identifier and a profile, will be allocated to said SIM card.

Each application, stored or designed to be stored either in the SIM, or in the terminal is also described by a unique application identifier AIN and by an associated application profile APD. The structure of the application profile must be comparable to the structure of the terminal profile, but it can be different therefrom or non-equivalent thereto. In the implementation, the application profile describes, in the form of a string of bits Fa(1), Fa(2) . . . , Fa(n), the list of the functions used by the application in question. A bit placed at “1” then indicates that the function in question that is encoded by said bit Fa(i) is used by the application, and a bit placed at “0” indicates that the function in question is not used.

If the application is linked to another application of the device for the purpose of being executed, with it being possible for said other application to be stored in the terminal or in the SIM card, said information can also be encoded in the application profile.

All of the functions accommodated by a terminal (or by the SIM card) and the functions used by an application are thus described in their profiles. The structure of a profile associated with an application, and the structure of a profile associated with a terminal (or with a SIM card) are similar, thereby enabling the profiles to be compared in part or on full.

FIG. 2 shows an example of functional architecture for implementing the method of the invention, which architecture is based on set of processing devices formed by a mobile terminal D1 combined with a SIM card D2 with which it co-operates, storing and executing a plurality of applications A1, A2, A3 et A4. More precisely, the applications A1 and A2 are stored in the terminal D1, whereas the applications A3 and A4 are stored in the SIM card D2.

A configuration module 10 in the form of a piece of software, is designed to manage and to update a configuration table 20, describing the combination of the hardware and software components of the set formed by D1 and D2 and A1 to A4, so as to be capable of determining the essential operating characteristics of the various applications depending on their execution environment.

For this purpose, the configuration module includes a synchronization module 30 whose role is to obtain, at (1) in FIG. 2, the current description of the characteristics of the devices and applications that co-operate with one another. For example, the synchronization module is implemented during switching-on of the terminal. The configuration table 20 is then updated if necessary.

Thus, in the example described, the synchronization module 30 makes it possible to obtain the description of the characteristics DCT1 of the terminal D1, formed by the terminal identifier and the terminal profile as descried above and, in the same way, the description of the characteristics DCT2 of the SIM card D2, as well as the descriptions of the characteristics ACT1 to ACT4 associated respectively with the applications A1 to A4.

The configuration module is thus capable of detecting and of updating changes in configuration (e.g. a change in device by the user, an upgrade of the functions accommodated by the terminal, etc.) via its synchronization module.

The updated table 20 then stores the profiles associated with the devices D1, D2 and with the applications A1 to A4. The configuration table 20 also stores the execution environment associated with each application and the links existing between each application for the purposes of executing the applications. Thus, for each application A1 to A4, the table describes the following information: the terminal device D1 or SIM card D2 in which it is stored for execution purposes (Dev. H), the device D1 or D2 optionally necessary for executing certain actions required by the application (Dev. C), and the application to which it is optionally linked for the purpose of being executed (Appli. L).

Once the configuration table has been updated, a compatibility module, in the form of a piece of software can be implemented at (3) for automatically establishing a diagnostic of functional compatibility between the various applications and devices, based on a comparison of their respective profiles depending on the configuration profiles defined in the table.

The compatibility module can be implemented on request or automatically, e.g. when the user changes mobile terminal, when the terminal is switched on, when a new application is downloaded, at the request of a server, etc.

Finally, a decision module 50 can be provided for co-operating with the compatibility module. The decision module is provided at (4) for triggering specific actions depending on the functional compatibility diagnostic established by the compatibility module.

An implementation is described in more detail below by way of example, enabling a functional compatibility diagnostic to be established by the module 40 in various scenarios.

Thus, in a first scenario corresponding to what is described in FIG. 2, the compatibility module 40 effects a diagnostic of the functional compatibility between the application A1 stored in the terminal and the terminal device D1. As explained above, such a diagnostic is based on a comparison of the respective profiles of A1 and D1.

The compatibility module 40 executes a comparison algorithm consisting in bit-by-bit comparison, based on the exclusive OR logic function, of the respective bit sequences Fd1(i) and Fa1(i) making up the profiles of D1 and A1. The algorithm can then be written as follows:

C1(i)=Fd1(i)⊕Fa1(i) (1≦i≦1n), where Fd1(i) is the bit that encodes the possibility for D1 of accommodating the function described at the position i in the profile of D1; and Fa1(i) is the corresponding bit of the profile of A1 that indicates whether said function is used by A1; and ⊕ symbolizes the exclusive OR logic operation.

Thus, if at least one position i can be identified such that [(C1(i)=1) AND (Fd1(i)=0)], then that indicates that there exists a functional incompatibility between D1 and A1 for the function corresponding to the position 1.

In this scenario, the functional compatibility diagnostic established by the module 40 can consist in indicating the presence of at least one functional incompatibility or indeed, more precisely, can consist in determining a list of functions used by the application A1 that are not accommodated by the terminal D1. Various levels of diagnostic can thus be delivered.

Depending on the diagnostic delivered, specific actions can then be implemented by the decision module, such as, for example, an upgrade of the functions accommodated by the terminal or a deactivation of the functions used by the application that are not accommodated.

Such a diagnostic can be established in the same way in a second scenario aimed, for exampled at assessing the functional compatibility between the application A3, stored in the card, and, firstly the terminal D1 and secondly the card D2. The configuration table shows that the application A3 stored in the card D2 needs the terminal D1 which is supposed to execute certain actions required by A1.

In this scenario, establishing the functional compatibility diagnostic then consists, in addition to comparing the profile associated with A3 and the profile associated with the terminal D1, in comparing the profile associated with A3 and the profile associated with the card D2 that describes the functions accommodated by the card. The algorithm can then be written in the following manner for the two comparisons:

C1(i):=Fd1(i)⊕Fa3(i), (1≦i≦1n)

C2(i):=Fd2(i)⊕Fa3(i), (1≦i≦1n)

where Fd1(i) is the bit that encodes the possibility for D1 of accommodating the function described at the position i in the profile of D1; Fd2(i) is the bit that encodes the possibility for D2 of accommodating the function described at the position i in the profile of D2; and Fa3(i) is the corresponding bit of the profile of A3 that indicates whether the function at the position i is used by A3.

Thus, if at least one position i can be found such that [(C1(i)=1) AND (Fd1(i)=0)] OR [(C2(i)=1) AND (Fd2(i)=0)], then that indicates that there exists functional incompatibility between D1 and A3 and/or D2 and A3. A functional compatibility diagnostic can be established consisting for example in a list of functions used by the application A3 that are not accommodated by the terminal or by the card.

A practical case of use of this scenario typically concerns SIM Toolkit technology in which the STK application A3 is executed in the SIM card. The compatibility module compares the various SIM, terminal, and application profiles, as shown in FIG. 3, merely by comparing the binary sequences of said profiles as defined by the above-mentioned 3GPP Standard.

In an implementation, the configuration module and the compatibility module are stored in the SIM card of the terminal. The compatibility module can then be launched automatically, once the configuration table is updated, or indeed when the user wants to use an application. However, launching the compatibility module can be preconditioned by other types of events.

In the example of FIG. 3, the SIM Toolkit application in question is designed to use the “launch browser” function, as described by the bit placed at “1” indicated by an arrow at byte No. 9 of the application profile. The “launch browser” function enables a SIM Toolkit application to launch a browser for accessing the Internet on a Wireless Application Protocol (WAP) terminal.

Application by the compatibility module of the algorithm described with reference to the second scenario above results in a diagnostic of incompatibility being established for this function between the SIM Toolkit application and the terminal, which does not accommodate the “launch browser” function, as described by the bit placed at “0” indicated by an arrow at byte No. 9 of the terminal profile.

In the SIM Toolkit environment, comparison between the application and SIM card profiles is not essential. Conventionally, the functional perimeter of the card is larger than the functional perimeter of the application. The environment within which the functions used by the application can be limited thus corresponds substantially to the environment of the terminal. It is thus possible, in practice, to limit the comparison to comparing the functions used by the application with the functions accommodated by the terminal. However, since SIM Toolkit applications are executed in the SIM card, it can be advantageous to compare the functions of the application with the functions accommodated by the card.

Returning to the configuration example of FIG. 2, a third scenario can also be considered, aimed for example, at assessing the functional compatibility of the application A2, stored and executed in the terminal D1. The configuration table 20 shows that the application A2, stored in the terminal D1, needs the card D2, which is supposed to execute certain actions required by A2 and is, in addition, linked to the application A4 for the purpose of being executed, said application A4, stored in the card D2, needing the terminal D1 for being executed.

In this scenario, given the configuration table, establishing the functional compatibility diagnostic can then, in addition to comparing the profile associated with A2 respectively with the profile associated with the terminal D1 and with the profile associated with the card D2, consist in comparing the profile associated with the application A4 respectively with the profile associated with the terminal D1 and with the profile associated with the card D2. The algorithm implemented by the compatibility module can then be written as follows for the four comparisons:

C1(i):=Fd1(i)⊕Fa2(i), (1≦i≦1n)

C2(i):=Fd2(i)⊕Fa2(i), (1≦i≦1n)

C3(i):=Fd1(i)⊕Fa4(i), (1≦i≦1n)

C4(i):=Fd2(i)⊕Fa4(i), (1≦i≦1n)

where Fd1(i) is the bit that encodes the possibility for D1 to accommodate the function described at position in the profile of D1; Fd2(i) is the bit that encodes the possibility for D2 to accommodate the function described at position i in the profile of D2; Fa2(i) is the corresponding bit of the profile of A2 that indicates whether said function at position i is used by A2; and Fa4(i) is the corresponding bit of the profile of A4 that indicates whether said function at position i is used by A2[A4???]

Thus, if at least one position i can be found such that: [(C1(i)=1) AND (Fd1(i)=0)] OR [(C2(i)=1) AND (Fd2(i)=0)] OR [(C3(i)=1) AND (Fd1(i)=0)] OR [(C4(i)=1) AND (Fd2(i)==0)], then that indicates that there exists functional incompatibility between D1 and A2 and/or D2 and A2 and/or D1 and A4 and/or D2 and A4. A functional compatibility diagnostic can be established that, for example, consists of a list of functions used by the application A2 that are not accommodated by the terminal or by the card.

A practical case of use of this scenario typically concerns J2ME technology in which the customer application is executed in a terminal having a J2ME platform. The practical case of use could, for example, be a Java application (A2) in compliance with the specification JSR177, authorizing communication between the Java terminal and a SIM card accommodating advanced functions, it then being possible, for example, for the application to access cryptographic signature functions offered by an advanced SIM application (A4).

For this purpose, the terminal profile as described using the SIM Toolkit environment is extended to include the J2ME functions accommodated by the terminal. Bytes are then added to the terminal profile that are dedicated to the J2ME functions, as appears in the example in FIG. 4. The same applies for the application profiles. The configuration module must then be capable of retrieving the extended profiles associated with the terminal and with the SIM card, and the extended profiles associated with the applications.

In the example of FIG. 4, the Java application in question (A2) is designed to use a message signature function, as described by the bit placed at “1” indicated by an arrow at byte No. 23 of the application profile A2. The message signature function is delivered by the SIM application A4, which accommodates this function, as described by the bit placed at “1” indicated by an arrow at byte No. 23 of the application profile A4. The card itself accommodates this function as shown by its profile.

Application by the compatibility module of the algorithm described with reference to the third scenario above then results in a diagnostic of incompatibility being established for this function between the Java application and the terminal, since said terminal does not accommodate the message signature function in question, as described by the bit placed at “0” indicated by an arrow at byte No. 23 of the terminal profile.

The invention thus makes it possible for a mobile operator to know whether an application that is to be downloaded, either into the SIM card, or into the terminal, is compatible with the terminal (and optionally with the SIM card). If a diagnostic establishing functional incompatibility is established, it is then possible to upgrade the functions of the terminal and/or of the card and/or to deactivate certain functions of the application.

The three main modules making it possible to implement the method of the invention, namely the configuration module, the compatibility module, and the decision module can be implemented and distributed separately, either at the customer end, on the SIM card and/or on the mobile terminal, or at the server end, or indeed at both the customer end and the server end at the same time.

In addition, the implementation described with reference to the various scenarios for comparing the application and terminal profiles making it possible to establish the functional compatibility diagnostic are not limited to the approach mentioned that is based on a comparison of the binary sequences making up the profiles.

The implementation described refers to profiles whose structures are made up of strings of bytes. However, without going beyond the ambit of the present invention, the application and terminal profiles could have other structures. For example, they could be made up of strings of objects classified into trees describing the accommodated functions, in which case the comparison of the profiles for obtaining the functional compatibility diagnostic could be based on an analysis of the object structure type.

1. A method of assessing compatibility between at least one application and at least one processing device that interacts with said application, by performing a comparison between at least one profile from among profiles that are associated with devices and that respectively describe functions accommodated by each device, and at least one profile from among profiles that are associated with applications and that respectively describe functions used by each application, to thereby automatically establish a diagnostic of functional compatibility between one or more applications and one or more devices.

2. A method according to claim 1, wherein said application is designed to interact while it is being executed with functions accommodated by a device comprising a mobile terminal and wherein the step establishing of the diagnostic of functional compatibility comprises performing a comparison whereby the profile that is associated with said terminal, and that describes the functions accommodated by said terminal, is compared with the profile that is associated with said application.

3. A method according to claim 2, wherein the application is hosted in a device comprising a SIM card with which the mobile terminal co-operates, and wherein the step of establishing the diagnostic of functional compatibility further comprises performing a comparison whereby the profile that is associated with said application is compared with a profile that is associated with the SIM card and that describes the functions accommodated by said card.

4. A method according to claim 2 wherein the application is linked, for the purposes of being executed, to at least one other application, and wherein the step of establishing the diagnostic of functional compatibility further comprises performing a comparison whereby the profile that is associated with said other application is compared with the profile that is associated with said terminal.

5. A method according to claim 4, wherein said other application is stored in a SIM card with which said terminal co-operates, and wherein the step of establishing the diagnostic of compatibility further comprises performing a comparison whereby the profile that is associated with said other application is compared with a profile that is associated with the SIM card and that describes the functions accommodated by said card.

6. A method according to claim 2, wherein the step of establishing the diagnostic of functional compatibility further comprises determining a list of the functions that are used by the application and/or by at least one other application to which it is linked, and that are not accommodated by the device.

7. A method according to claim 1, wherein the profiles are stored and updated in a configuration table that stores the execution environment associated with each application and the links existing between each application for the purposes of executing them.

8. A method according to claim 1, further comprising the steps of triggering specific actions depending on the compatibility diagnostic that is established.

9. A method according to claim 8, wherein the triggering of specific actions comprises upgrading the device(s) or in deactivating those functions used by the application(s) which are not accommodated.

10. A method according to claim 1, wherein said method is implemented in a customer device.

11. A method according to claim 1, wherein said method is implemented in a server.

12. A computer-readable medium containing a software module for assessing the compatibility between at least one application and at least one processing device interacting with said application, wherein said software module comprises instructions for causing a computer system to execute a comparison between at least one profile from among profiles that are associated with devices and that respectively describe functions accommodated by each device, and at least one profile from among profiles that are associated with applications and that respectively describe functions used by each application, to thereby automatically establish a diagnostic of functional compatibility between one or more applications and one or more devices.

13. A mobile terminal incorporating a software module according to claim 12.

14. A smart card, incorporating a software module according to claim 12.
